(19) United States
(12) Patent Application Publication
(10) Pub. No.: US 2015/0276084 A1
(43) Pub. Date: Oct. 1, 2015

(54) Pressure control valve

(71) Applicant: KENDRION (Villingen) GmbH, Villingen-Schwenningen (DE)

(72) Inventors: Ralf Heingl, Villingen-Schwenningen (DE); Harald Burkart, Villingen-Schwenningen (DE); Volker Lehmann, Moenchweiler (DE); Bjoern Bergfeld, Balingen-Endingen (DE)

(21) Appl. No.: 14/611,523

(22) Filed: Feb. 2, 2015

(30) Foreign Application Priority Data
Feb. 11, 2014 (DE) 10 2014 101 664.5

(51) Int. Cl. F16K 31/06; F16K 3/316

(52) U.S. Cl. CPC F16K 31/0668; F16K 3/316

(57) ABSTRACT

The invention relates to a pressure control valve (1), comprising a valve body (2) with a control room (9) comprising a valve device (16) and a magnetic coil (4), with radially extending tank bores (20b) ending in the control room (9), an anchor (5), which is movable in an anchor chamber (6) by electrifying the magnetic coil (4), an anchor slide (7) guided by the valve body (2), which at one end is effectively connected to the anchor (5) and at the other end projects into the control room (9) of the valve body (2) to operate the valve device (16), whereby for the generation of pressure compensation, the anchor (5) is embodied between the anchor chamber (6) and the control room (9) with at least one axial pressure compensation bore (10), and the anchor slide (7) being supported in a bearing (8b) of the valve body (2) at the control room side showing at least one pressure compensation groove (14a, 14b). According to the invention it is provided that the mouth (14aa, 14bb) of the at least one pressure compensation groove (14a, 14b) of the bearing (8b) at the control room side in the control room (9) is aligned to the mouth (20bb) of the at least one tank bore (20b) in the control room (9) or at least approximately aligned thereto.

### CROSS REFERENCE TO RELATED APPLICATIONS

This patent application claims priority to German Patent Application 10 2014 101 664.5, filed on Feb. 11, 2014.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

1. Field of the Invention

The present invention relates to a pressure control valve.

2. Background of the Invention

A pressure control valve for a high-pressure storage unit or a high-pressure feed pump of a fuel injection system of an internal combustion engine for a motor vehicle is known from patent application WO2012/123086 A1 of the applicant.

In this known pressure control valve, comprising a valve body accepting a magnetic coil, which shows a control room provided with a valve device, an anchor is moved in an anchor chamber in the direction of a facial end of the valve body by electrifying a magnetic coil. This anchor is connected to an anchor slide guided through the valve body and projecting into the control room. In order to generate pressure compensation between the anchor chamber and the control room, on the one hand the anchor is embodied with at least one axial pressure compensation bore and on the other hand the two bearings of the anchor slide each comprise at least one pressure compensation groove.

Thus in this known pressure control valve it is possible to achieve direct pressure compensation between the anchor chamber and the control room so that the occurrence of pressure pulsa-tions in the valve device, operated by the anchor slide is considerably reduced.

With such a pressure control valve the injection pressure in this Diesel Common-Rail injection system can be controlled very precisely and shows high stability both with regards to high-pressure fluctuations as well as increasingly elevated pressures at the low-pressure side.

The invention is based on the objective to provide an improved pressure control valve of the type mentioned at the outset.

This objective is attained in a pressure control valve showing the features as described and claimed herein.

### BRIEF SUMMARY OF THE INVENTION

In a preferred embodiment, a pressure control valve, comprising:
a valve body with a control room including a valve device and a magnetic coil, with radially extending tank bores ending in a control room,
an anchor that can be displaced in an anchor chamber by electrifying the magnetic coil,
an anchor slide guided through the valve body, which at one end is in an effective connection to the anchor and at the other end projects into the control room of the valve body to operate the valve device,
with, for the generation of pressure compensation between the anchor chamber the control room, the anchor being embodied with at least one axial pressure compensation bore and the anchor slide being supported in a bearing at the control room side of the valve body with at least one pressure compensation groove , wherein
the mouth of the at least one pressure compensation groove of the bearing at the control room side is arranged in the control room aligned to the mouth of the at least one tank bore in the control room or at least almost aligned thereto.

The pressure control valve of claim 1, wherein the at least one pressure compensation groove of the bearing at the control room side extends in the radial level of the at least one tank bore.

In another preferred embodiment, the pressure control valve as described herein, wherein the bearing at the control room side shows two diagonally opposite pressure compensation grooves, with their mouths being aligned in the control room each to a mouth of the tank bore in the control room.

In another preferred embodiment, the pressure control valve as described herein, wherein the anchor slide is supported in another bearing at the anchor side with at least one pressure compensation groove.

In another preferred embodiment, the pressure control valve as described herein, wherein the at least one pressure compensation bore is arranged in the anchor radially adjacent to the circumference of the anchor slide.

In another preferred embodiment, the pressure control valve as described herein, wherein the at least one pressure compensation bore of the anchor is aligned to the at least one pressure compensation groove of the bearing at the control room side and/or the anchor side.

In another preferred embodiment, the pressure control valve as described herein, wherein the bearing at the anchor side is embodied with four axial pressure compensation grooves evenly distributed over the interior circumference, each showing a cross-section from 0.30 mm2 to 0.50 mm2 or two axial pressure compensation grooves, located diametrically opposite each other on the interior circumference, each showing a cross-section from 0.50 mm2 to 1.50 mm2.

### BRIEF DESCRIPTION OF THE DRAWINGS

FIG. 1 is a line drawing evidencing a cross-sectional illustration of a pressure control valve according to the invention.

FIG. 2 is a line drawing evidencing a top view of a bearing site of the pressure control valve at the anchor side according to FIG. 1.

FIG. 3 is a line drawing evidencing a cross-sectional illustration according to the line A-A of a control room of the pressure control valve according to FIG. 1 with a view to a bearing at the control room side.

FIG. 4 is a line drawing evidencing two time-pressure diagrams.

### DETAILED DESCRIPTION OF THE INVENTION

The invention is a pressure control valve comprising:
a valve body with a control room including a valve device and a magnetic coil, with the radially extending tank bores ending in the control room,
an anchor, which is movable in an anchor chamber by electrifying the magnetic coil,
an anchor slide guided through the valve body, which at one end is in an effective connection to the anchor and at the other end projects into the control room of the valve body for operating the valve device,
with the anchor being embodied with at least one axial pressure compensation bore for the generation of pressure compensation between the anchor chamber and the control room, and the anchor slide being supported in a bearing of the valve body at the side of the control room with at least one pressure compensation groove,
characterized according to the invention in that the mouth of at least one pressure compensation groove of the bearing at the side of the control room is arranged in the control room aligned with the mouth of at least one tank bore in the control room or at least arranged almost aligned thereto.

With such a radial or almost radial alignment of the pressure compensation groove, also called oil compensation groove, of the bearing at the control room side to a radially extending tank bore, here a consistent pressure progression is achieved during the control of the valve device, for example the high-pressure valve of the pressure control valve. This way, a consistently con-trollable pressure is ensured in the pressure volume flow of the valve device, without pressure fluctuations developing.

In one advantageous embodiment of the invention a simply designed realization is given such that at least one pressure compensation groove or oil compensation groove of the bearing at the control room side extends in the radial level of at least one tank bore.

According to another embodiment of the invention it is particularly advantageous when the bearing at the control room side shows two diagonally opposite pressure compensation grooves, with their mouths in the control room respectively being aligned to a mouth of the tank bore in the control room.

Further it is advantageous when, according to a further development, the anchor slide is supported in another bearing at the anchor side with at least one pressure compensation groove. This way, a precise guidance of the anchor slide in the valve body is ensured, whereby, based on the pressure compensation grooves inside the two bearings, additionally the friction is reduced due to the smaller contact areas.

A particularly advantageous embodiment of the invention develops with an arrangement of at least one pressure compensation bore in the anchor adjacent radially to the circumference of the anchor slide. Due to the fact that this pressure compensation bore is arranged directly adjacent to the anchor slide, direct pressure compensation with the control room develops.

According to a further development of the invention it is particularly advantageous when at least one pressure compensation bore of the anchor is aligned to the pressure compensation groove of the bearing at the anchor side and/or the control room side, so that in a fluid application, a fluid exchange is achieved as directly as possible, and thus also pressure compensation.

In this method according to the invention it is particularly effective when the pressure compensation grooves in the bearing sites are embodied sufficiently large. Preferably, for this purpose four pressure compensation grooves distributed over the interior circumference are inserted in the bearing at the anchor side and two pressure compensation grooves, located diametrically opposite thereto, are inserted in the bearing at the control room side each showing a cross-section from 0.30 mm2 to 0.50 mm2. The two bearings may also each be embodied with only two pressure compensation grooves, which preferably may be embodied each with a cross-section from 0.50 mm2 to 1.50 mm 2.

### DETAILED DESCRIPTION OF THE FIGURES

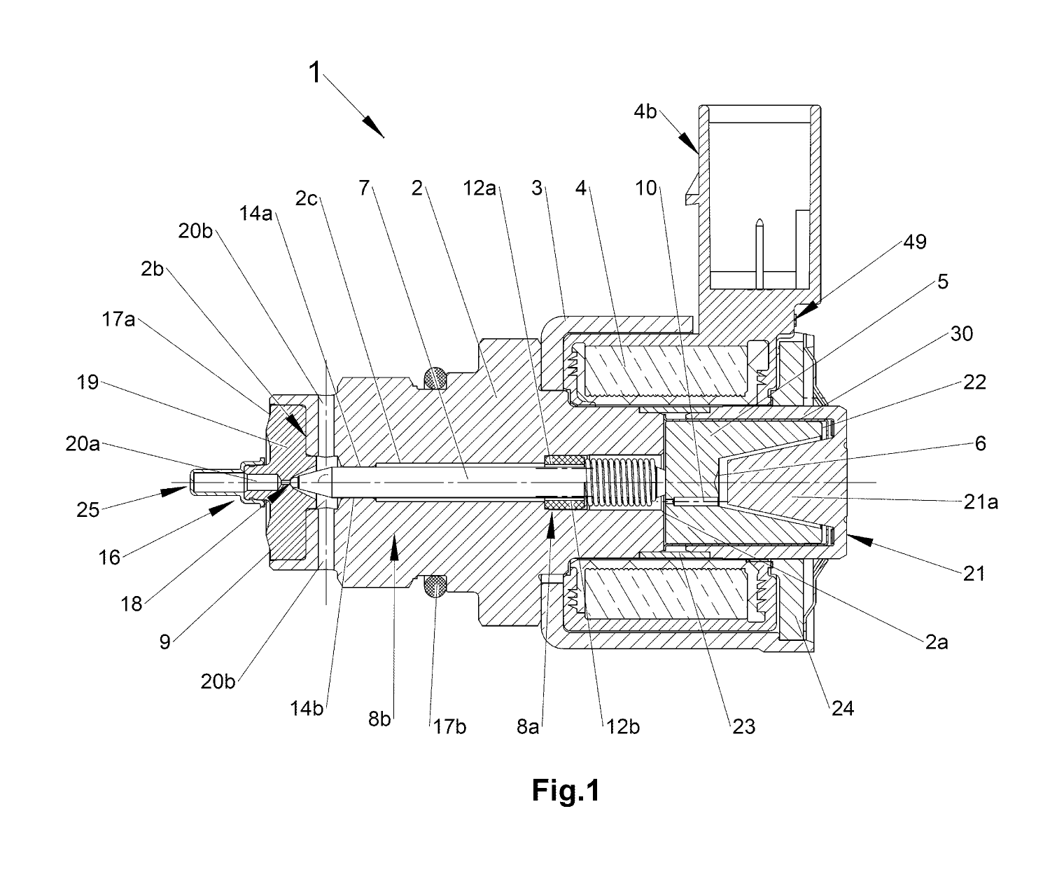

The pressure control valve 1 shown in FIG. 1 serves as a high-pressure control valve for a high-pressure storage unit or a high-pressure feed pump of a fuel injection system of an internal combustion engine of a motor vehicle.

This pressure control valve 1 according to FIG. 1 comprises a valve body 2 made from a soft-magnetic material, to which a cup-shaped bearing lid 21 is connected on a face 2a at the anchor side, via a connection generated by a connection ring 23, in order to form an anchor chamber 6 for a cylindrical anchor 5. The anchor 5 is here supported in a sheath. Within this cup shape of the bearing lid 21, starting at its bottom part, a frustum-shaped section 21a ex-tends in the direction of the face 2a of the valve body 2. The anchor 5 comprises a bore 5a, adjusted to the contour of this frustum-shaped section 21a, which can enter into this section 21a.

A section of the valve body 2 at the end-side and the section of the connected bearing lid 21 is radially encompassed by a magnetic coil 4 arranged in a coil accept 4a, with the magnetic coil 4 being accepted by a cup-shaped coil accept 3. The coil accept 4a is additionally provided with a connection plug 4b. The lid element 24 forms the end of the connection of the pressure control valve 1 at the side of the bearing lid 21.

The anchor 5 is impinged by a flat spring and/or spring disk, encompassing the frustum-shaped section 21 [sic: 21a] of the bearing lid 21, as a pressure spring 22 in the direction of the face 2a of the valve body 2 and/or the seat valve 16, which is supported towards the bearing lid 21. The bearing lid 21 and the pressure spring 22 limit the stroke of the anchor 4 in the anchor chamber 6.

At the face 2b of the valve body 2 facing away from the anchor a valve device 16 is embodied in the form of a seat valve. This pressure control valve 1 is screwed with this valve body 2 into a high-pressure storage unit (not shown), with the high-pressure side being sealed via a cutting edge 17a from the low-pressure side, while sealing against the environment occurs via a seal 17b.

In this pressure control valve 1, via the high-pressure side, a fluid flow is controlled by the valve device 16 and, via a control room 9, as a release room, drained in the radially extending tank bores 20b as drainage bores towards the low-pressure side. The valve device 16 is operated by a valve slide 7, which is axially guided via a valve slide bore 2c through the valve body 2 and is in an effective connection at the face 2a of the valve body 2, at the side facing away from the control room, with the anchor 5 and/or is connected thereto. The anchor chamber 6 embodied at the same face 2a of the valve body 2 allows a stroke motion of the anchor 5 to operate the sealing element 18, which in the present case is embodied as a valve ball.

The valve slide 7 is supported in an axially mobile fashion in the axial valve slide bore 2c of the valve body 2 via a bearing 8a at the anchor side and a bearing 8b at the control room side 8b, and is embodied conically at its end at the side of the seat valve, in order to allow the operation of operating a spherical sealing element 18 of the seat valve 16 there. The valve seat for this valve ball 18 is formed by a valve seat element 19, which is arranged at the face in a blind bore of the valve body 2 and shows a channel 20a towards the Common Rail, which can be closed by the valve ball 18, generating, via a filter element 25, a connection to the high-pressure storage unit.

In the axial section of the valve device 16 the valve body 2 shows the control room 9, which is connected via the radially extending tank bores 20b in the valve body 2 to a tank system (not shown).

When this pressure control valve 1 is connected, for example, to a high-pressure storage unit, its high-pressure causes in the non-electrified state of the magnetic coil 4 that the valve ball 18 lifts off its valve seat, allowing the medium to drain from the high-pressure storage unit via the tank bores 20b. By electrifying the magnetic coil 4 the anchor 5 is pulled against the face 2a of the valve body 2 so that via the valve slide 7 the valve ball 18 is pressed into the valve seat of the seat valve 16, allowing control of the flow depending on the coil current and thus also control of the high-pressure.

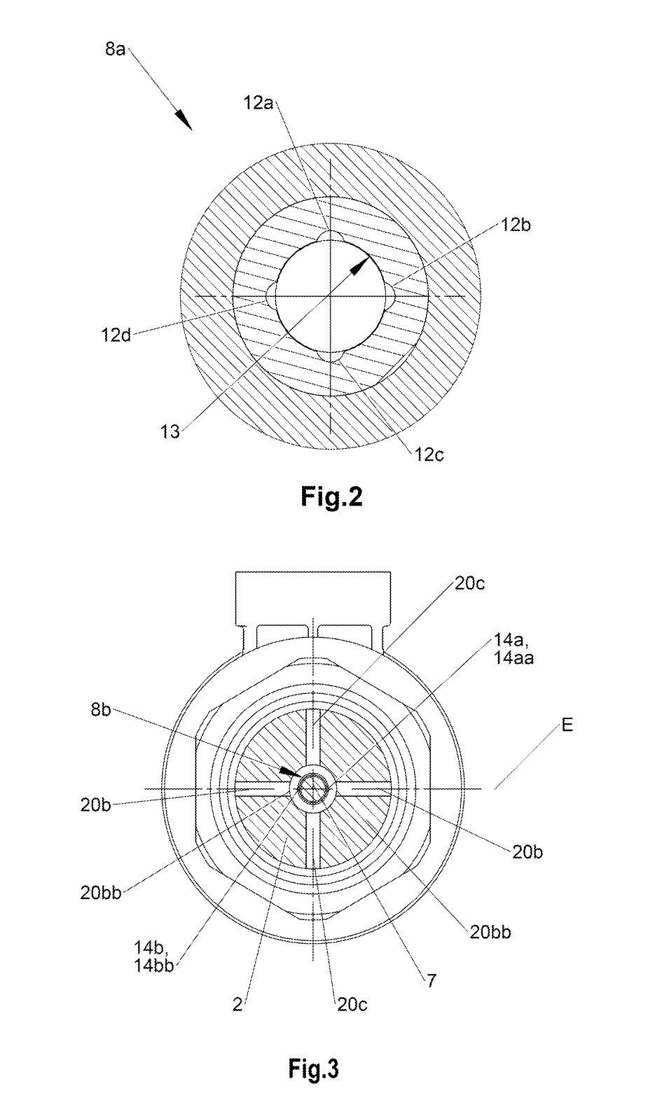

In order to realize pressure compensation between the control room 9 and the anchor chamber 6, on the one hand a pressure compensation bore 10 (cf. FIG. 1) is provided in the anchor 5 and on the other hand a bearing 8a in the valve slide bore 2c at the anchor side, and pressure compensation grooves 12a to 12c and/or 14a and 14b are provided in the bearing 8b at the control room side, as explained in the following based on FIGS. 2 and 3.

The bearing 7a at the anchor side represents a bearing socket made from plastic, for example Torlon®, which is pressed into the valve slide bore 2c and with its top view being shown in FIG. 2. On the inside surface 13 of this bearing 8a, which is formed as a bearing sheath, pressure compensation grooves 12a, 12b, 12c, and 12d are arranged distributed evenly over the circumference. The pressure compensation bores 10 are aligned to one of the four pressure compensation grooves 12a to 12d in order to achieve a direct fluid compensation.

FIG. 3 shows, in the section A-A guided through the control room 9 in the area of the tank bore 20b, a top view of the bearing 8b at the control room side, which according to FIG. 1 is arranged in the valve slide bore 2c at the face of the valve body 2 facing away from the anchor. On the inside surface of this bearing 8b, at the control room side, two diametrically opposite axial pressure compensation grooves 14a and 14b are arranged. These pressure compensation grooves 14a and 14b may be aligned to the pressure compensation grooves of the bearing socket 8a at the anchor side.

Furthermore, the two pressure compensation grooves 14a and 14b in the bearing 8b at the control room side are respectively aligned to a tank bore 20b. This means that at least the mouth 14aa of the pressure control groove 14a in the control room 9 is aligned to the mouth 20bb of a tank bore 20b in the control room 9, and in the same fashion the mouth 14bb of the pressure compensation groove 14b in the control room 9 is aligned to the mouth 20bb of the diametrically opposite tank bore 20b in the control room 9. Finally, it is discernible from FIGS. 1 and 3 that the two pressure compensation grooves 14a and 14b extend in a radial level E representing the level of symmetry of the tank bores 20b.

Pressure compensation is achieved between the anchor chamber 6 and the control room 9 by the pressure compensation bore 10 in the anchor 5 and the pressure compensation grooves 12a to 12d and/or 14a and 14b in the two bearings 8a and 8b, so that any pressure pulsations in the connected pressure storage unit (Common Rail) have no effects on the valve elements, but flow around all valve elements.

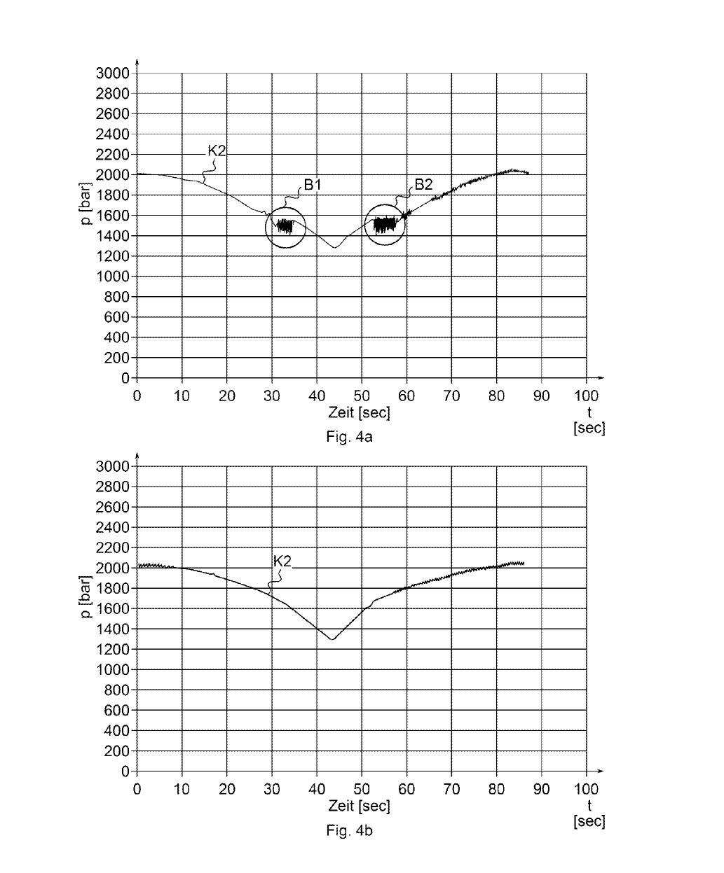

Furthermore, by the radial alignment of the two pressure compensation grooves 14a and 14b in the bearing 8b at the control room side, a consistent pressure progression is achieved at the two tank bores 20b with the control of the seat valve 16, as is discernible from the pressure-time diagrams according to FIG. 4. Accordingly, FIG. 4a shows the time-dependent pressure progression p over the duration of one control process with a pressure control valve 1 according to prior art, in which therefore the pressure compensation grooves 14a and 14b of a bearing 8b at the control room side are not aligned to the tank bores 20b. The curve K1 in this diagram according to FIG. 4a shows fierce pressure fluctuations in two sections B1 and B2. Com-pared thereto, in the diagram according to FIG. 4b, the curve K2 shows a consistent pressure progression without any such deflections. This curve K2, according to FIG. 4b, was generated via a pressure control valve 1 according to FIGS. 1 to 3, in which the pressure compensation grooves 14a and 14b of the bearing 8b at the control room side are aligned to the tank bores 20b.

This alignment of the pressure compensation grooves 14a and 14b to these tank bores 20b therefore ensures a consistent pressure progression during the reduction of the volume flow at the seat valve 16 without any pressure fluctuations developing in the connected injection sys-tem of an internal combustion engine.

The bearing 8a at the anchor side may also be embodied with only two pressure compensation grooves 12a and 12c instead of four pressure compensation grooves. Accordingly, it is also possible for the bearing 8b at the control room side to be embodied with four pressure compensation grooves instead of two pressure compensation grooves 14a and 14b.

The degree of pressure compensation between the anchor chamber 6 and the control room 9 can be adjusted by sizing the pressure compensation bores and/or by their number when the sum of the cross-sections of the pressure compensation grooves in the two bearings 8a and 8b respectively is sufficiently large. The latter-most condition can be achieved either by enlarging the cross-section and/or increasing the number of pressure compensation grooves in the bearings 8a and 8b.

With regards to the bearing 8b at the control room side, this means that when using two pressure compensation grooves 14a and 14b for a pressure compensation groove a cross-section from 0.50 mm2 to 1.50 mm2 and a cross-section from 0.30 mm2 to 0.50 mm2 for four pressure compensation grooves is sufficient. Of course, more than four pressure compensation grooves may also be provided for this purpose.

The pressure compensation grooves 12a to 12d of the bearing 8a at the anchor side each show a cross-section from 0.30 mm2 to 0.50 mm2. When only two pressure compensation grooves are provided for this bearing 8a, a cross-section from 0.50 mm2 to 1.50 mm2 is sufficient. This bearing 8a may also be embodied with more than four pressure compensation grooves.

In order to adjust the pressure compensation, the cross-section of the pressure compensation bore 10 of the anchor 5 may range from 2.50 mm2 to 4.50 mm2. It is also possible to provide several pressure compensation bores in the anchor 5. In this case their cross-sections may be appropriately reduced. The bores 10 may show e.g., a cross-section of 0.5 mm.

LIST OF REFERENCE NUMBERS

1 Pressure control valve

2 Valve body

2a Face of the valve body 2 at the anchor side

2b Face of the valve body 2 at the side facing away from the anchor

2c Valve slide bore

3 Coil accept

4 Magnetic coil

4a Coil accept of the magnetic coil

4b Connection plug of the coil accept 4a

5 Anchor

5a Blind bore of the anchor 5

6 Anchor chamber

7 Anchor slide, valve slide

8a Bearing, bearing sheath

8b Bearing

9 Control room, drainage room

10 Pressure compensation bore of the anchor

12a-12d Pressure compensation grooves in the bearing 8a

13 Interior surface of the bearing 8a

14a Pressure compensation groove of the bearing 8b

14aa Mouth of the pressure compensation groove 14a

14b Pressure compensation groove of the bearing 8b

14bb Mouth of the pressure compensation groove 14b

15 Valve device, seat valve

17a Cutting edge

17b Seal

18 Seal element, valve ball

19 Valve seat element

20a Channel

20b Tank bore, drainage bore

20bb Mouth of the tank bore 20b

21 Bearing lid

21a frustrum-shaped section of the bearing lid 21

22 Pressure spring

23 Connecting ring

24 Lid element

25 Filter element

E Radial level of the tank bore 20b

B1 Detail of the curve K2

B2 Detail of the curve K2

K1 Curve of the p-t-diagram according to FIG. 5a

K2 Curve of the p-t-diagram according to FIG. 5b

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable equivalents.

1. A pressure control valve (1), comprising:
a valve body (2) with a control room (9) including a valve device (16) and a magnetic coil (4), with radially extending tank bores (20b) ending in a control room (9),
an anchor (5) that can be displaced in an anchor chamber (6) by electrifying the magnetic coil (4),
an anchor slide (7) guided through the valve body (2), which at one end is in an effective connection to the anchor (5) and at the other end projects into the control room (9) of the valve body (2) to operate the valve device (16),
with, for the generation of pressure compensation between the anchor chamber (6) the control room (9), the anchor (5) being embodied with at least one axial pressure compensation bore (10) and the anchor slide (7) being supported in a bearing (8b) at the control room side of the valve body (2) with at least one pressure compensation groove (14a, 14b),
characterized in that
the mouth (14aa, 14bb) of the at least one pressure compensation groove (14a, 14b) of the bearing (8b) at the control room side is arranged in the control room (9) aligned to the mouth (20bb) of the at least one tank bore (20b) in the control room (9) or at least almost aligned thereto.

2. A pressure control valve (1) according to claim 1,
characterized in that
the at least one pressure compensation groove (14a, 14b) of the bearing (8b) at the control room side extends in the radial level (E) of the at least one tank bore (20b).

3. A pressure control valve (1) according to claim 1 or 2,
characterized in that
the bearing (8b) at the control room side shows two diagonally opposite pressure compensation grooves (14a, 14b), with their mouths (14aa, 14bb) being aligned in the control room (9) each to a mouth (20bb) of the tank bore (20b) in the control room (9).

4. A pressure control valve (1) according to one of the previous claims,
characterized in that
the anchor slide (7) is supported in another bearing (8a) at the anchor side with at least one pressure compensation groove (12a-12d).

5. A pressure control valve (1) according to one of the previous claims,
characterized in that
the at least one pressure compensation bore (10) is arranged in the anchor (5) radially adjacent to the circumference of the anchor slide (7).

6. A pressure control valve (1) according to one of the previous claims,
characterized in that
the at least one pressure compensation bore (10) of the anchor (5) is aligned to the at least one pressure compensation groove (12a-12d, 14a, 14b) of the bearing (8a, 8b) at the control room side and/or the anchor side.

7. A pressure control valve (1) according to claims 4 to 6,
characterized in that
the bearing (8a) at the anchor side is embodied with four axial pressure compensation grooves (12a-12d) evenly distributed over the interior circumference (13), each showing a cross-section from 0.30 mm² to 0.50 mm² or two axial pressure compensation grooves (12a, 12b), located diametrically opposite each other on the interior circumference, each showing a cross-section from 0.50 mm² to 1.50 mm².
